(19) United States
(12) Patent Application Publication
(10) Pub. No.: US 2026/0233830 A1
(43) Pub. Date: Aug. 13, 2026

(54) HYDROGEN CONTAINMENT AIRPLANE FLOAT TECHNOLOGY

(71) Applicant: Wipaire, Inc., South St. Paul, MN (US)

(72) Inventors: Charles R. Wiplinger, Inver Grove Heights, MN (US); Bradley T. Kutz, Lakeville, MN (US)

(21) Appl. No.: 19/533,995

(22) Filed: Feb. 9, 2026

Related U.S. Application Data
(60) Provisional application No. 63/756,382, filed on Feb. 10, 2025.

(51) Int. Cl. B64C 25/12; B63B 22/20; B64C 25/54; B64C 25/66; B64C 35/00; F17C 1/06

(52) U.S. Cl. CPC B64C 25/12; B63B 22/20; B64C 25/54; B64C 25/66; B64C 35/001; F17C 1/06; F17C 2203/0648; F17C 2221/012; F17C 2223/0161

(57) ABSTRACT

The invention provides a float for a float plane, where the float includes a supply of hydrogen. Preferably, the float comprises a hull, and the hydrogen tank is contained entirely inside the hull. In some embodiments, the invention provides a pair of floats for a float plane, where at least one float of the pair is equipped with a hydrogen tank. Furthermore, certain embodiments provide a float plane comprising a fuselage, a wing depending from the fuselage, as well as first and second floats mounted to the fuselage, where at least one of the first and second floats is equipped with a hydrogen tank.

### CROSS-REFERENCE TO RELATED APPLICATIONS

This application claims priority to U.S. Provisional Patent Application No. 63/756,382, filed Feb. 10, 2025, the contents of which are incorporated herein by reference in their entirety.

### TECHNICAL FIELD

The present invention relates to airplanes. More specifically, the invention relates to floats for float planes.

### BACKGROUND OF THE INVENTION

A great deal of work has been done, and continues to be done, to develop systems that use hydrogen to power propulsion of an airplane. In some cases, a fuel cell is powered by hydrogen to generate electricity that powers the propulsion of an airplane. In other cases, hydrogen is burned in an internal combustion engine on the aircraft. These and other hydrogen power technologies, as well as various hybrid technologies, can be used to power an airplane using hydrogen.

A float plane is a seaplane typically having a pair of pontoons, known as floats. The floats typically are connected to the fuselage of the plane. The floats are configured to provide buoyancy on water, such that the float plane can takeoff from, and land on, the surface of a lake, river, ocean, or other body of water.

Hydrogen power for airplanes is advantageous because it offers low emissions (or even zero emissions, with certain hydrogen technologies). It is therefore a promising option for reducing the environmental impact of aviation.

As taught in the present disclosure, it would be desirable to power float planes with hydrogen, and the floats of a float plane offer unique opportunities for hydrogen storage. It would therefore be desirable to provide a float construction that includes one or more hydrogen tanks. Furthermore, it would be desirable to provide a float plane having two floats, where at least one of the two floats is (preferably both are) equipped with one or more hydrogen tanks.

### SUMMARY OF THE INVENTION

In some embodiments, the present disclosure provides a float for a float plane, where the float is equipped with a hydrogen tank. This disclosure provides advantageous constructions for such a float. In some cases, the float includes two hydrogen tanks. In other cases, the float only includes a single hydrogen tank.

Furthermore, certain embodiments provide a pair of floats for a float plane, where at least one float of the pair is equipped with a hydrogen tank. In some cases, each float of the pair is equipped with at least one hydrogen tank. If desired, there can be two hydrogen tanks in each float.

Certain embodiments of this disclosure provide a float plane that includes a fuselage, a wing (e.g., two wings) depending from the fuselage, as well as first and second floats mounted to the fuselage. In the present embodiments, at least one of the first and second floats is equipped with a hydrogen tank. Various advantageous constructions are provided for such a float. Preferably, each of the two floats of the pair is equipped with a respective hydrogen tank. In such cases, there can optionally be two hydrogen tanks in each float.

Some embodiments of the invention provide a float plane that includes a fuselage, a wing depending from the fuselage, a first float mounted to the fuselage, and a second float mounted to the fuselage. In the present embodiments, the first float includes multiple (e.g., four) watertight compartments, and it is equipped with a first hydrogen tank. Similarly, the second float includes multiple (e.g., four) watertight compartments, and it is equipped with a second hydrogen tank. In these embodiments, in addition to the multiple (e.g., four) watertight compartments of the first float, the first hydrogen tank serves as an additional watertight compartment of the first float, and in addition to the multiple (e.g., four) watertight compartments of the second float, the second hydrogen tank serves as an additional watertight compartment of the second float, thereby configuring the float plane to exhibit positive upright buoyancy with the first and second floats floating on a body of water even if any two non-adjacent ones of the watertight compartments of either the first float or the second float become flooded with water.

### BRIEF DESCRIPTION OF DRAWINGS

FIG. 1A is a front view of a hydrogen-containment seaplane float in accordance with certain embodiments of the present disclosure;

FIG. 1B is a side view of the seaplane float of FIG. 1A;

FIG. 1C is a cross-sectional side view, taken along lines B-B of FIG. 1, of the seaplane float of FIG. 1A;

FIG. 2A is a front view of a hydrogen-containment amphibious float in accordance with other embodiments of the present disclosure;

FIG. 2B is a side view of the amphibious float of FIG. 2A;

FIG. 2C is a cross-sectional side view, taken along lines A-A of FIG. 2A, of the amphibious float of FIG. 2A;

FIG. 3 is a side view of a float plane having a fuselage, a wing depending from the fuselage, and first and second hydrogen-containment floats mounted to the fuselage in accordance with certain embodiments of the present disclosure;

FIG. 4A is a front view of a hydrogen-containment seaplane float in accordance with certain embodiments of the present disclosure;

FIG. 4B is a side view of the seaplane float of FIG. 4A; and

FIG. 4C is a cross-sectional side view, taken along the lines A-A of FIG. 4A, of the seaplane float of FIG. 4A in accordance with certain embodiments of the present disclosure.

### DETAILED DESCRIPTION

The following detailed description is to be read with reference to the drawings, in which like elements in different drawings have like reference numerals. The drawings, which are not necessarily to scale, depict selected embodiments and are not intended to limit the scope of the invention. Skilled artisans will recognize that the examples provided herein have many useful alternatives that fall within the scope of the invention.

A float plane is a type of seaplane typically having a pair of pontoons, also known as floats. The pair of floats is typically connected to the fuselage of the plane. The floats are configured to provide buoyancy on water, such that the float plane can takeoff from, and land on, the surface of a body of water, such as a lake, river, ocean, or other body of water. In more detail, the floats are configured to provide positive upright buoyancy to the float plane such that the float plane can remain in an upright orientation (with the fuselage disposed above the floats and/or above the surface of the water) when the floats are floating on the surface of the body of water.

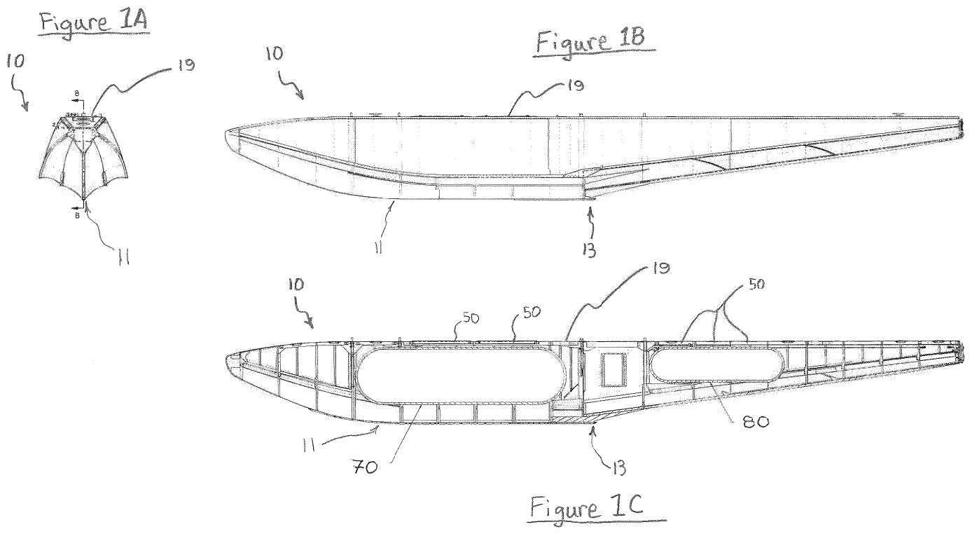

A first group of embodiments provides a float for a float plane, where the float includes a supply of hydrogen. Reference is made to the embodiments of FIGS. 1A-1C, 2A-2C, and 4A-4C.

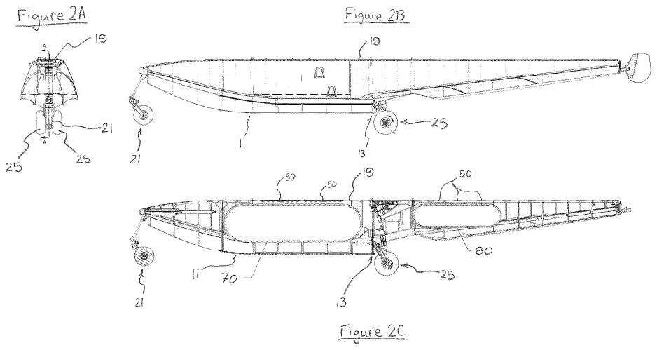

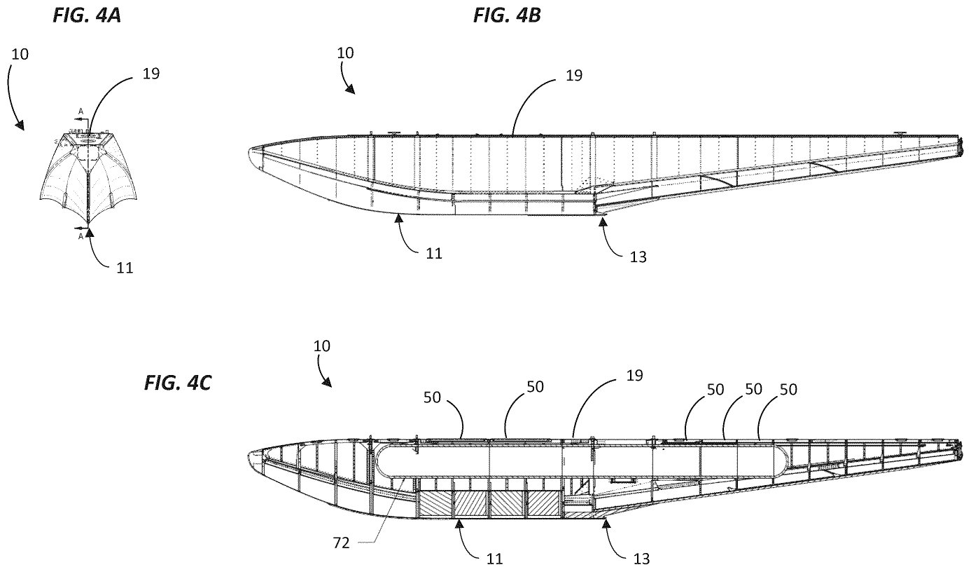

In the present embodiments, the float 10 preferably is equipped with one or more hydrogen tanks 70, 72, 80. In the non-limiting examples shown in FIGS. 1A-1C and 2A-2C, the float 10 includes two hydrogen tanks 70, 80. It is to be appreciated, however, that a single hydrogen tank can alternatively be provided in the float. Reference is made to the non-limiting example shown in FIG. 4A-4C.

Thus, one or more hydrogen tanks preferably are integrated into the float 10. In more detail, the float 10 comprises a hull, and the hydrogen tank(s) preferably are contained entirely inside the hull. This is the case for the embodiments of FIGS. 1A-1C and 2A-2C. This is also the case for the embodiment of FIG. 4A-4C.

The illustrated float 10 has a top side (or “deck”), a bottom side (or “float bottom”), a front (or “fore”) end, a rear (or “aft”) end, and a main region (or “span”) extending between the front and rear ends. Preferably, the float bottom has a keel 11.

The float 10 can be of any float style and is not limited to the details shown in the figures. Thus, the shape and construction of the float can vary. For example, the top side of the float can be substantially planar, e.g., parallel to horizontal, optionally with a slight downward taper at a front end region. Alternatively, the top side of the float can include no such tapered sections (e.g., only straight/flat sections), or it can curve downwardly or upwardly at either or both of the front and rear ends. The bottom side of the float can include straight sections, as well as curved and/or tapered sections. For example, the float bottom can curve and/or taper upwardly at one or both of the front and rear end regions. Reference is made to FIGS. 1B, 1C, 2B, 2C, 4B, and 4C. If desired, the float bottom may be flat, convex, or concave. Thus, various float configurations are contemplated and within the scope of this disclosure. If desired, each float can have an elongated generally tubular shape. A variety of advantageous float styles can be obtained commercially from Wipaire, Inc. (South St. Paul, Minnesota, USA).

One non-limiting example of an advantageous, commercially available float configuration that can be redesigned to integrate one or more hydrogen tanks is the Wipline® 8750 float, which is commercially available from Wipaire. As noted above, however, a wide range of float shapes, types, and models can benefit from the present invention. Thus, the present float is by no means required to involve any particular shape, type, or model.

If desired, the float 10 can have a hull/walls comprising (e.g., consisting essentially of, or consisting of) a composite material. When provided, the composite material preferably comprises fiberglass, although other composite materials, such as carbon fiber, can be used. In some cases, the hull/walls of the float are formed entirely of composite material (other than optionally having some metal components), or the float hull/walls can include some areas formed of a composite material while other areas are formed of a non-composite material (e.g., metal). In preferred embodiments, though, the float hull/walls are aluminum or another aircraft metal.

Preferably, the (or each) hydrogen tank has a generally cylindrical configuration. This can optionally be the case for each of the two hydrogen tanks 70, 80 in FIGS. 1A-1C and 2A-2C. Likewise, this can optionally be the case for the hydrogen tank 72 in FIG. 4A-4C. In certain embodiments, there is at least one hydrogen tank having a diameter that is greater than 40%, greater than 50%, or even greater than 55% of a maximum height of the float (not including any wheels/landing gear).

In some embodiments, the hydrogen tank has a tank wall formed of polymer, composite, or both. As one example, the hydrogen tank can optionally have a tank wall formed of a composite material. As another example, the hydrogen tank can optionally have a tank wall comprising a polymer liner reinforced by a composite material, such as carbon fiber. In other embodiments, the hydrogen tank has a wall formed of metal, such as stainless steel or aluminum. In some cases, the hydrogen tank has a tank wall comprising a metal liner reinforced by a composite material, such as fiberglass or carbon fiber.

Preferably, the (or each) hydrogen tank contains gaseous hydrogen. In more detail, the hydrogen tank preferably contains pressurized gaseous hydrogen. In such cases, the pressurized gaseous hydrogen can, for example, be at a pressure of 5,000 psi or greater, such as in a range of 5,000 psi to 10,000 psi. In other embodiments, the hydrogen tank contains liquid hydrogen. Suitable hydrogen tanks, for either gaseous hydrogen or liquid hydrogen, as well as the hydrogen itself, can be obtained from a variety of commercial suppliers, such as Air Liquide USA, e.g., Airgas, Inc. (Radnor, PA, USA).

As noted above, the float 10 preferably has a deck 19. As is perhaps best appreciated by referring to FIGS. 1A and 2A, the deck can optionally be substantially flat. Additionally or alternatively, the deck 19 of the float 10 can optionally be equipped with a tank hatch 50, such that an operator can access the hydrogen tank by opening the tank hatch. If desired, a plurality of tank hatches 50 can be provided in the deck 19. Reference is made to the non-limiting examples of FIGS. 1C, 2C, and 4C.

Preferably, the float 10 has a top deck 19, as well as a float bottom comprising a keel 11. In some embodiments, the hydrogen tank 70 is located closer to the top deck 19 than to the keel 11. This is the case in the embodiments of FIGS. 1A-1C, 2A-2C, and 4A-4C. In some cases, an arrangement of this nature can facilitate using hydrogen tank(s) of considerable length, which can help ensure positive upright buoyancy to the float plane in certain circumstances. More generally, the preferred hydrogen tanks and the rest of the two floats can advantageously be configured to provide positive upright buoyancy to the float plane even if any two non-adjacent ones of the internal (normally watertight) compartments of either float were to flood with water. In more detail, due to the configuration (and the resulting water displacement) of the preferred hydrogen tanks and the rest of the two floats, in the event that any two non-adjacent compartments of either float were to become flooded with water, the float plane can still maintain positive upright buoyancy. This can advantageously be the case for any embodiment of the present disclosure. Additionally or alternatively, the hydrogen tank 70 can be disposed in a space (e.g., a dedicated tank space) that is surrounded (at least partially, or entirely) by a plurality of internal compartments (and/or by a plurality of sections of one or more such compartments) of the float. In FIGS. 1A-1C, lower open portions (or “air cavities”) of such a plurality of internal compartments are located directly below the hydrogen tank 70. This is also the case for the optional second hydrogen tank 80. Likewise, this preferably is the case for the hydrogen tank 72 shown in FIG. 4A-4C.

The illustrated float 10 includes a plurality of bulkheads spaced apart along the length of the float. Preferably, the hydrogen tank 70 or 72 spans two or more of the bulkheads, three or more of the bulkheads, four or more of the bulkheads, or even five or more of the bulkheads. This is perhaps best appreciated by referring to FIGS. 1C and 2C. This is also preferably the case for the hydrogen tank 72 shown in FIG. 4A-4C.

Thus, the float 10 preferably includes a tank space in which the hydrogen tank 70 is received. In more detail, the float preferably includes an interior seat configured to removably receive (e.g., removably seat) the hydrogen tank. Likewise, this preferably is the case for the hydrogen tank 72 and float 10 embodiment shown in FIG. 4A-4C. In addition to the tank space, the float 10 includes a plurality of other watertight compartments. There preferably are two or more, three or more, or even four or more such compartments. The tank space preferably is separated from those other watertight compartments (e.g., by at least one bulkhead).

Each float can optionally include a hydrogen tank seat comprising seat portions at (e.g., defined by) a plurality of bulkheads and/or other upright walls of the float. Each seat portion may comprise a semi-cicular seat bare (e.g., bounding a semi-circular cut-out or space) configured to receive the hydrogen tank. In such cases, the hydrogen tank when mounted in the float may be rested in plurality (e.g., three or more) of such seat bases. If desired, each such seat base may be configured to seal to the hydrogen tank, optionally in a watertight manner.

As noted above, the float 10 can optionally include a second hydrogen tank 80. In embodiments of this nature, the second hydrogen tank can optionally be received in a second tank space. In such cases, the two tank spaces preferably are at different locations along the length of the float. Furthermore, these two tank spaces preferably are separated from each other (e.g., by at least one bulkhead) in a watertight manner. In addition to these two tank spaces, the float 10 preferably includes a plurality of other watertight compartments. There preferably are two or more, three or more, or even four or more such compartments.

The float 10 preferably has a float bottom with a step 13. In some embodiments of this nature, the hydrogen tank 70 is located fore of the step 13. A hydrogen tank 70 located fore of the step 13 can be referred to as a fore hydrogen tank. Additionally or alternatively, the float can optionally include a second hydrogen tank 80. When provided, the second hydrogen tank 80 can optionally be located aft of the step. In such cases, it can be referred to as an aft hydrogen tank. Reference is made to FIGS. 1A-1C and 2A-2C.

Another option is to provide in the float 10 a single hydrogen tank that extends from a front end located fore of the step to a rear end located aft of the step. A single hydrogen tank of this nature can optionally be provided in combination with any one or more other features disclosed herein for any embodiment of the present disclosure. FIG. 4A-4C illustrate one non-limiting example.

In embodiments that include both a fore hydrogen tank 70 and an aft hydrogen tank 80, the fore hydrogen tank can optionally have a greater length and/or a greater vertical dimension (e.g., a greater cylinder radius) than the aft hydrogen tank. This is shown in the non-limiting examples of FIGS. 1A-1C and 2A-2C.

In certain embodiments, the float 10 is an amphibious float. This is shown in FIGS. 2A-2C. Here, the float 10 includes retractable wheels 21, 25. Each retractable wheel is movable between a retracted position and an extended position. In these embodiments, the float 10 preferably includes a retractable front wheel (or “nose wheel”) 21 and at least one retractable mid-point wheel (or “main wheel”) 25. In the embodiment of FIGS. 2A-2C, hydrogen tank 70 is located fore of the main wheels 25, and hydrogen tank 80 is located aft of the main wheels 25. Here, the hydrogen tank 70 located fore of the main wheels is referred to as the forward (or fore) hydrogen tank, and the hydrogen tank 80 located aft of the main wheels is referred to as the rearward (or aft) hydrogen tank. Advantageous amphibious landing gear of this nature are commercially available from Wipaire.

In one subgroup of embodiments, the hydrogen tank is equipped with an air-pressure system configured to fill the hydrogen tank with air upon reaching a certain extent of hydrogen depletion in the hydrogen tank. For example, the hydrogen tank can optionally be equipped with an air-pressure system configured to fill the hydrogen tank with pressurized air at a suitable pressure in response to reaching a certain extent of hydrogen depletion in the hydrogen tank. Furthermore, the float 10 can optionally include a safeguard system configured to prevent the aircraft from consuming this pressurized air from the hydrogen tank. In some embodiments, the hydrogen tank may use an air compressor, or “bleed air” from the aircraft engine (e.g., compressed air taken from the compressor section of an aircraft's engine), to pressurize ambient air and pump it into the hydrogen tank; this may occur when the amount of hydrogen remaining in the hydrogen tank has been depleted to a certain extent (e.g., to a predefined level of remaining hydrogen in the tank, or to a nearly empty level). In some embodiments, an air compressor may be configured to pump pressurized air into the depleted hydrogen tank until it reaches a certain pressure or falls within a defined pressure range, for example. In some embodiments, bleed air from the aircraft engine may be directed into the depleted hydrogen tank until it reaches a certain pressure or falls within a defined pressure range, for example. In embodiments using an air compressor, the air compressor may be controlled by pressure switches to determine pressure set-points, for example, a lower pressure limit at which the air compressor turns on, and an upper pressure limit at which the air compressor turns off. In embodiments using bleed air, the flow of bleed air from the aircraft's engine may be controlled by pressure switches to determine pressure set-points, for example, a lower pressure limit at which bleed air is directed into the hydrogen tank, and an upper pressure limit at which the flow of bleed air into the hydrogen tank is stopped or turned off.

In preferred embodiments of the present disclosure, the invention provides a pair of floats for a float plane, and at least one float of the pair is equipped with a hydrogen tank. In such cases, the hydrogen-containment float can be of any nature described above. Preferably, each of the two floats is equipped with a hydrogen tank. In some cases, each float 10 is equipped with two hydrogen tanks 70, 80. In embodiments that involve a pair of hydrogen-containment floats, each float can be of any nature described above (e.g., each such float can include any combination of features described above).

In another group of embodiments, the invention provides a float plane comprising a fuselage, a wing (e.g., two wings) depending from the fuselage, as well as first and second floats mounted to the fuselage, wherein at least one of the first and second floats is equipped with a hydrogen tank. Preferably, each of the first and second floats is equipped with a respective hydrogen tank. More generally, each of the two floats can be of any nature described above (e.g., each such float can include any combination of features described above).

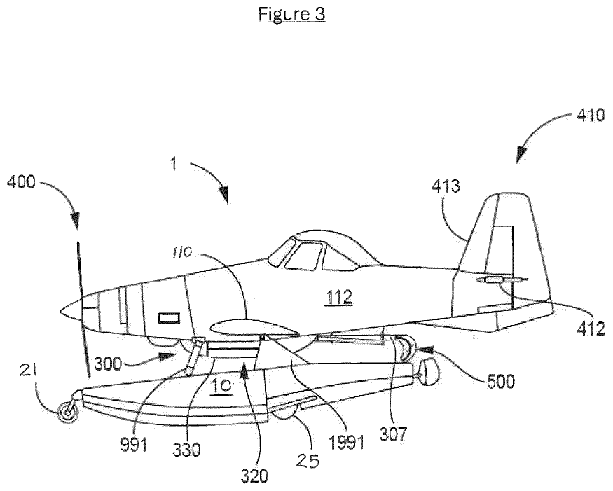

FIG. 3 shows one non-limiting example of a float plane 1 having a fuselage 112, a wing (e.g., two wings) 110, and a pair of floats 10. The two floats may be referred to individually herein as a first float (or left or “port” float) and a second float (or right or “starboard” float). (These designations are as viewed from a pilot's perspective within the float plane, as is conventional.)

The fuselage 112 defines a main body of the float plane 1. Continued reference is made to the non-limiting example of FIG. 3. The fuselage 112 generally has a top region and a bottom region (or “belly”), front (or “fore”) and rear (or “aft”) end regions, and left (or “port”) and right (or “starboard”) side regions. The front end region includes a nose of the fuselage, and the rear end region includes a tail region of the fuselage. The illustrated nose is equipped with a propeller 400. In some cases, the float plane 1 has only a single propeller 400. In other cases, the float plane includes two propellors. For example, various twin-engine float planes can be used. In still other cases, the float plane may have a push-pull arrangement defined collectively by a frontward-facing first propellor and a rearward-facing second propellor. If desired, the aircraft can have one or two turbo-prop or jet engines.

In FIG. 3, the illustrated tail region includes a tail 410, which has stabilizing surfaces (e.g., a vertical stabilizer 413 and a horizontal stabilizer 412) to provide an empennage. Various other tail configurations can be used. More generally, it is to be appreciated that, in accordance with the present invention, hydrogen-containment floats can be provided advantageously on various types of float planes. Thus, the present float plane can be provided with various fuselage, wing, propulsion, and tail arrangements.

As will be appreciated from the present disclosure, the float plane 1 is provided with either a fuel cell powered by hydrogen or an internal combustion engine that burns hydrogen. Various fuel cells or internal combustion engines, including those known currently and others developed in the future, can be used.

FIG. 3 shows an embodiment where the float plane 1 is equipped for fighting fires. Here, the illustrated float plane 1 includes a water scooping apparatus 500, a water tank 300, and a fire gate 320. The illustrated water scooping apparatus 500 comprises an elongated scoop tube 307. In other firefighting embodiments, however, first and second water scoops of any desired configuration can be provided respectively on the first and second floats. In still other embodiments, the float plane is not intended for firefighting, and therefore does not include water scooping features.

In the present embodiment group, the first and second floats 10 are spaced apart from each other and connected to the fuselage 112. In more detail, the illustrated floats 10 are mounted to the fuselage 112 such that they are held in positions spaced below and laterally offset from the fuselage. Thus, the two floats 10 preferably are spaced apart from each other (e.g., laterally) and spaced apart from the fuselage (e.g., spaced below the fuselage).

In the present embodiment group, the float plane preferably includes a hydrogen delivery line extending from the first float or the second float to the fuselage. The float plane includes a strut package by which the first and second floats are mounted to the fuselage, and the hydrogen delivery line can optionally extend along (e.g., can be mounted alongside or inside) a strut and/or pylon of the strut package. Preferably, the float plane includes first and second hydrogen delivery lines extending respectively from the first and second floats to the fuselage. In such cases, each hydrogen delivery line can optionally extend along (e.g., can be mounted alongside or inside) a respective strut and/or pylon of the strut package.

The (or each) hydrogen delivery line preferably is configured to deliver hydrogen from a float to a fuel cell or an internal combustion engine located on the float plane (e.g., in the fuselage). The fuel cell or internal combustion engine is configured to power propulsion of the float plane. The particular propulsion system, however, is not the focus of this disclosure. Rather, as noted above, the present float plane 1 can use any desired engine(s)/propulsion system that is powered by hydrogen.

The strut package preferably comprises a plurality of struts 991 and/or pylons 1991. In the non-limiting example of FIG. 3, the strut package comprises a plurality of struts 991 and a plurality of pylons 1991. Here, there are two main pylons 1991, although only one is visible in the drawing. Since FIG. 3 shows the left (port) side of the float plane 1, the strut 991 and main pylon 1991 on the right (starboard) side are concealed from view. If desired, the strut package can include front cross wires (or “flying wires”), rear cross wires, or both. Advantageous strut packages can be obtained commercially from Wipaire.

In some embodiments, a hydrogen delivery line extending from the first float or the second float to the fuselage passes from such float, through a main pylon 1991, and into the fuselage 112. Preferably, the float plane 1 includes first and second hydrogen delivery lines respectively extending from the first and second floats 10, through first and second main pylons 1991, and into the fuselage 112.

In some embodiments, the float plane 1 is an amphibious float plane that includes retractable wheels 21, 25 on the first and second floats 10. Preferably, each of the retractable wheels 21, 25 is movable between a retracted position and an extended position. In more detail, each of the first and second floats 10 can optionally include a retractable front wheel (or “nose wheel”) 21 and a retractable mid-point wheel (or “main wheel”) 25. In such cases, hydrogen tank 70 can optionally be located fore of the mid-point wheels. As noted above, a second hydrogen tank 80 can optionally be provided in each float 10. If desired, a second hydrogen tank 80 in each float can optionally be located aft of the main wheels 25, e.g., as exemplified in FIGS. 2A-2C.

The first and second floats 10 respectively have first and second top decks 19, which preferably are equipped respectively with first and second tank hatches 50, such that an operator can access first and second hydrogen tanks 70 by respectively opening the first and second tank hatches 50.

In certain embodiments, the first float includes a first tank space in which a first hydrogen tank is received, and the first float further includes one or more other watertight compartments. In addition, in some preferred embodiments, the second float includes a primary tank space in which a second hydrogen tank is received, and the second float further includes one or more other watertight compartments. Preferably, the float plane 1 is configured to exhibit and/or maintain positive upright buoyancy with the first and second floats 10 floating on a body of water even if any two non-adjacent compartments of either float become flooded with water. This can optionally be the case for any embodiment of this disclosure. Preferably, the first tank space is separated from one or more other watertight compartments of the first float by at least one bulkhead, and the primary tank space preferably is separated from one or more other watertight compartments of the second float by at least one bulkhead.

As noted above, each float 10 can optionally have a hull/walls comprising (e.g., consisting essentially of, or consisting of) a composite material. Additionally or alternatively, the fuselage or certain portions thereof can have walls comprising (e.g., consisting essentially of, or consisting of) a composite material. When provided, the composite material preferably comprises fiberglass, although other composite materials, such as carbon fiber, can be used. In some cases, the hull/walls of each float, and/or the walls of the fuselage, can be formed entirely of composite material (other than optionally having some metal components), or the float and/or fuselage walls can include some areas formed of a composite material while other areas are formed of a non-composite material (e.g., metal). In preferred embodiments, though, the fuselage walls are aluminum or another aircraft metal. Likewise, the float hull/walls can advantageously be aluminum or another aircraft metal. Another option is for the fuselage walls to be aluminum or another aircraft metal, while the float hull/walls are formed of composite material.

FIG. 4A-4C show various views of a hydrogen-containment seaplane float in accordance with some alternative embodiments of the present disclosure. For example, the embodiment of float 10 depicted in FIG. 4A-4C includes a single (i.e., only one) hydrogen tank 72, integrated or housed within float 10, as shown in FIG. 4C. In more detail, the float 10 comprises a hull, and hydrogen tank 72 can be contained entirely inside the hull.

The illustrated float 10 has a top side or deck 19, a bottom side (or “float bottom”), a front (or “fore”) end (to the left in FIGS. 4B and 4C), a rear (or “aft”) end (to the right in FIGS. 4B and 4C), and a main region (or “span”) extending between the front and rear ends. Preferably, the float bottom has a keel 11.

Similar to the embodiments described above with respect to FIGS. 1C and 2C, the hydrogen tank 72 shown in FIG. 4C can have a generally cylindrical configuration. In some embodiments, hydrogen tank 72 has a tank wall formed of polymer, composite, or both. As one example, the hydrogen tank can optionally have a tank wall formed of a composite material. As another example, the hydrogen tank can optionally have a tank wall comprising a polymer liner reinforced by a composite material, such as carbon fiber. In other embodiments, the hydrogen tank has a wall formed of metal, such as stainless steel or aluminum. In some cases, the hydrogen tank has a tank wall comprising a metal liner reinforced by a composite material, such as fiberglass or carbon fiber.

As noted above, the float 10 preferably has a deck 19. Deck 19 can optionally be substantially flat. Additionally or alternatively, the deck 19 of the float 10 can optionally be equipped with a tank hatch 50, such that an operator can access the hydrogen tank 72 by opening the tank hatch 50. If desired, a plurality of tank hatches 50 can be provided in the deck 19 along a length of float 10 to provide access to hydrogen tank 72 at various points, as illustrated in FIG. 4C.

Preferably, the float 10 has a top deck 19, as well as a float bottom comprising a keel 11. In some embodiments, the hydrogen tank 72 is located closer to the top deck 19 than to the keel 11. This is the case in the embodiment depicted in FIG. 4C. This is advantageous for installing, servicing, or otherwise accessing the hydrogen tank 72. It may also be advantageous for buoyancy or stability in certain situations. Additionally, or alternatively, the hydrogen tank 72 can be disposed in a space (e.g., a dedicated tank space) that is surrounded (at least partially, or entirely) by a plurality of internal compartments of the float 10. In FIG. 4C, lower open portions (or “air cavities”) of such a plurality of internal compartments are located directly below the hydrogen tank 72.

The hydrogen tank 72 can optionally have a length that is greater than 40%, greater than 45%, or even greater than 50% of the length of the float. In addition, the hydrogen tank 72 can be optionally cylindrical. In such cases, it can optionally have a diameter that is less than 50%, less than 45%, or even less than 40% of the maximum height of the float 10 (excluding any landing gear/wheels on the float).

The illustrated float 10 includes a plurality of bulkheads spaced apart along the length of the float 10. Preferably, the hydrogen tank 72 spans two or more of the bulkheads, three or more of the bulkheads, four or more of the bulkheads, or even five or more of the bulkheads. This is perhaps best appreciated by referring to the embodiment shown in FIG. 4C.

Thus, the float 10 preferably includes a tank space in which the hydrogen tank 72 is received. In more detail, the float preferably includes an interior seat configured to removably receive (e.g., removably seat) the hydrogen tank 72. In addition to the tank space, the float 10 includes a plurality of other watertight compartments. There preferably are two or more, three or more, or even four or more such other watertight compartments. More generally, the float 10 includes multiple (e.g., at least four) watertight compartments. This preferably is the case for any embodiment of the present disclosure. The tank space, which itself can optionally be a watertight compartment, is preferably separated from at least some other watertight compartments (e.g., by at least one bulkhead). If desired, however, the tank space can be (e.g., before the tank 72 is seated therein) open to a plurality of the watertight compartments.

The float 10 can have a float bottom with a step 13, as shown in FIGS. 4B and 4C. In some embodiments of this nature, a single hydrogen tank 72 can be positioned to extend from a front end located fore of the step 13 to a rear end located aft of the step 13, e.g., generally as shown in FIG. 4C. A single hydrogen tank 72 can optionally be provided in combination with any one or more other features disclosed by the present disclosure.

In one subgroup of embodiments, the hydrogen tank 72 is equipped with an air-pressure system configured to fill the hydrogen tank with air upon reaching a certain extent of hydrogen depletion in the hydrogen tank. For example, the hydrogen tank can optionally be equipped with an air-pressure system configured to fill the hydrogen tank with pressurized air at a suitable pressure in response to reaching a certain extent of hydrogen depletion in the hydrogen tank. Furthermore, the float 10 can optionally include a safeguard system configured to prevent the aircraft from consuming this pressurized air from the hydrogen tank. In some embodiments, the hydrogen tank may use an air compressor, or “bleed air” from the aircraft engine (e.g., compressed air taken from the compressor section of an aircraft's engine), to pressurize ambient air and pump it into the hydrogen tank; this may occur when the amount of hydrogen remaining in the hydrogen tank has been depleted to a certain extent (e.g., to a predefined level of remaining hydrogen in the tank, or to a nearly empty level). In some embodiments, an air compressor may be configured to pump pressurized air into the depleted hydrogen tank until it reaches a certain pressure or falls within a defined pressure range, for example. In some embodiments, bleed air from the aircraft engine may be directed into the depleted hydrogen tank until it reaches a certain pressure or falls within a defined pressure range, for example. In embodiments using an air compressor, the air compressor may be controlled by pressure switches to determine pressure set-points, for example, a lower pressure limit at which the air compressor turns on, and an upper pressure limit at which the air compressor turns off. In embodiments using bleed air, the flow of bleed air from the aircraft's engine may be controlled by pressure switches to determine pressure set-points, for example, a lower pressure limit at which bleed air is directed into the hydrogen tank, and an upper pressure limit at which the flow of bleed air into the hydrogen tank is stopped or turned off.

In preferred embodiments of the present disclosure, the invention provides a pair of floats for a float plane, and at least one float of the pair is equipped with a hydrogen tank. In such cases, the hydrogen-containment float can be of any nature described above. Preferably, each of the two floats is equipped with a hydrogen tank. In embodiments that involve a pair of hydrogen-containment floats, each float can be of any nature described above (e.g., each such float can include any combination of features described above).

In another group of embodiments, the invention provides a float plane comprising a fuselage, a wing (e.g., two wings) depending from the fuselage, as well as first and second floats mounted to the fuselage, wherein at least one of the first and second floats is equipped with a hydrogen tank. Preferably, each of the first and second floats is equipped with a respective hydrogen tank. More generally, each of the two floats can be of any nature described above (e.g., each such float can include any combination of features described above).

Thus, various embodiments of a hydrogen-containment float and a float plane are disclosed. One skilled in the art will appreciate that the present invention can be practiced with embodiments other than those disclosed. The disclosed embodiments are presented for purposes of illustration and not limitation, and the invention is limited only by the claims that follow.

What is claimed is:

1. A float plane comprising a fuselage, a wing depending from the fuselage, first and second floats mounted to the fuselage, and at least one of the first and second floats being equipped with a hydrogen tank.

2. The float plane of claim 1, wherein the hydrogen tank contains pressurized gaseous hydrogen at a pressure of 5,000 psi or greater.

3. The float plane of claim 1, wherein the float plane includes a strut package, the first and second floats mounted to the fuselage by the strut package, the float plane further comprising a hydrogen delivery line extending from the first float or the second float to the fuselage, the hydrogen delivery line extending along a strut and/or a pylon of the strut package.

4. The float plane of claim 1, wherein the first and second floats each have a float bottom with a step, and the hydrogen tank is located fore of the step.

5. The float plane of claim 4, wherein the hydrogen tank located fore of the step is a fore hydrogen tank, and further comprising an aft hydrogen tank, the aft hydrogen tank being located aft of the step.

6. The float plane of claim 1, wherein the first and second floats each include a plurality of bulkheads spaced apart along a float length, and the hydrogen tank spans two or more of the bulkheads.

7. The float plane of claim 1, wherein the first and second floats each have a top deck as well as a float bottom comprising a keel, and the hydrogen tank is located closer to the top deck than to the keel.

8. The float plane of claim 1, wherein the float plane is an amphibious float plane that includes retractable wheels on the first and second floats, each of the retractable wheels being movable between a retracted position and an extended position, such that each of the first and second floats includes a retractable nose wheel and a retractable main wheel, and the hydrogen tank is located fore of the main wheels.

9. The float plane of claim 1, wherein the first and second floats are equipped respectively with first and second hydrogen tanks, wherein the first and second floats respectively have first and second top decks, the first and second top decks being equipped respectively with first and second tank hatches, such that an operator can access the first and second hydrogen tanks by respectively opening the first and second tank hatches.

10. The float plane of claim 1, wherein the first float includes multiple watertight compartments, the second float includes multiple watertight compartments, and wherein the first and second floats are equipped respectively with first and second hydrogen tanks, such that the first float includes a first tank space in which the first hydrogen tank is received, and the second float includes a primary tank space in which the second hydrogen tank is received, wherein in addition to the multiple watertight compartments of the first float, the first hydrogen tank serves as an additional watertight compartment of the first float, and wherein in addition to the multiple watertight compartments of the second float, the second hydrogen tank serves as an additional watertight compartment of the second float, thereby configuring the float plane to exhibit positive upright buoyancy with the first and second floats floating on a body of water even if any two non-adjacent ones of the watertight compartments of either the first float or the second float become flooded with water.

11. The float plane of claim 1, wherein the first float includes four watertight compartments, the second float includes four watertight compartments, and wherein the first and second floats are equipped respectively with first and second hydrogen tanks, such that the first float includes a first tank space in which the first hydrogen tank is received, and the second float includes a primary tank space in which the second hydrogen tank is received, wherein in addition to the four watertight compartments of the first float, the first hydrogen tank serves as an additional watertight compartment of the first float, and wherein in addition to the four watertight compartments of the second float, the second hydrogen tank serves as an additional watertight compartment of the second float, thereby configuring the float plane to exhibit positive upright buoyancy with the first and second floats floating on a body of water even if any two non-adjacent ones of the watertight compartments of either the first float or the second float become flooded with water.

12. The float plane of claim 1, wherein the hydrogen tank is equipped with an air-pressure system configured to fill the hydrogen tank with air upon reaching an extent of hydrogen depletion from the hydrogen tank.

13. The float plane of claim 12, further comprising a safeguard system configured to prevent the float plane from consuming such air from the hydrogen tank.

14. A pair of floats for a float plane, at least one float of the pair being equipped with a hydrogen tank.

15. The pair of floats of claim 14, wherein the hydrogen tank has a generally cylindrical configuration, the hydrogen tank having a tank wall comprising a polymer liner reinforced by a composite material, the hydrogen tank configured to contain pressurized gaseous hydrogen.

16. The pair of floats of claim 14, wherein the first and second floats each have a float bottom with a step, and the hydrogen tank is located fore of the step.

17. The pair of floats of claim 16, wherein the hydrogen tank located fore of the step is a fore hydrogen tank, and further comprising an aft hydrogen tank, the aft hydrogen tank being located aft of the step.

18. The pair of floats of claim 17, wherein the fore hydrogen tank has a greater length and a greater vertical dimension than the aft hydrogen tank.

19. The pair of floats of claim 14, wherein the first and second floats each include a plurality of bulkheads spaced apart along a float length, and the hydrogen tank spans four or more of the bulkheads.

20. The pair of floats of claim 14, wherein the hydrogen tank is one of first and second hydrogen tanks respectively included in the first and second floats, and wherein the first and second floats respectively have first and second top decks, the first and second top decks being equipped respectively with first and second tank hatches, such that an operator can access the first and second hydrogen tanks by respectively opening the first and second tank hatches.

21. The pair of floats of claim 14, wherein the hydrogen tank is equipped with an air-pressure system configured to fill the hydrogen tank with pressurized air upon reaching an extent of hydrogen depletion from the hydrogen tank.

22. The pair of floats of claim 21, further comprising a safeguard system configured to prevent the float plane from consuming such pressurized air from the hydrogen tank.

23. A float plane comprising:
a fuselage;
a wing depending from the fuselage;
a first float mounted to the fuselage, the first float including multiple watertight compartments, and the first float being equipped with a first hydrogen tank; and
a second float mounted to the fuselage, the second float including multiple watertight compartments, and the second float being equipped with a second hydrogen tank;
such that in addition to the multiple watertight compartments of the first float, the first hydrogen tank serves as an additional watertight compartment of the first float, and in addition to the multiple watertight compartments of the second float, the second hydrogen tank serves as an additional watertight compartment of the second float, thereby configuring the float plane to exhibit positive upright buoyancy with the first and second floats floating on a body of water even if any two non-adjacent ones of the watertight compartments of either the first float or the second float become flooded with water.

24. The float plane of claim 23 wherein the multiple watertight compartments of the first float comprise four watertight compartments, and the multiple watertight compartments of the second float comprise four watertight compartments.
